(19) United States
(12) Patent Application Publication
(10) Pub. No.: US 2010/0173682 A1
(43) Pub. Date: Jul. 8, 2010

(54) ALL-IN-ONE HEADSET, HANDSET, AND POWER SOURCE

(75) Inventor: Jason Ashton, Santa Cruz, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CommonWealth Intellectual Property Holdings, Inc., Scotts Valley, CA (US)

(21) Appl. No.: 12/684,815

(22) Filed: Jan. 8, 2010

Related U.S. Application Data
(60) Provisional application No. 61/143,219, filed on Jan. 8, 2009.

(51) Int. Cl. H04B 1/38

(52) U.S. Cl. 455/573

(57) ABSTRACT

The present invention relates to communications devices. More specifically, some embodiments relate to mobile devices having all-in-one features.

### CROSS-REFERENCES TO RELATED APPLICATIONS

This Application claims the benefit of and priority to U.S. Provisional Patent Application No. 61/143,219, filed Jan. 8, 2009 and entitled “ALL-IN-ONE HEADSET, HANDSET, AND POWER SOURCE,” which is hereby incorporated by reference for all purposes.

### BACKGROUND OF THE INVENTION

The present invention relates to communications devices. More specifically, some embodiments relate to mobile devices having all-in-one features.

### BRIEF SUMMARY OF THE INVENTION

The present invention relates to communications devices. More specifically, some embodiments relate to mobile devices having all-in-one features.

In some embodiments, all-in-one features may include a handset that is physically and technologically paired to a headset. In various embodiments, a mobile device may include a handset and a headset. The headset can be configured to physically and technologically integrate with the handset for charging and/or storage.

In further embodiments, all-in-one features may include application features of a handset that is physically and technologically paired to a headset.

A further understanding of the nature and the advantages of the inventions disclosed herein may be realized by reference of the remaining portions of the specification and the attached drawings.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings.

FIG. 1 is a simplified illustration of a mobile device that may incorporate an embodiment of the present invention.

FIG. 2 is a simplified illustration of a mobile device in one embodiment.

FIG. 3 is a simplified illustration of a mobile device in one embodiment.

FIG. 4 is a simplified illustration of a mobile device in one embodiment.

### DETAILED DESCRIPTION OF THE INVENTION

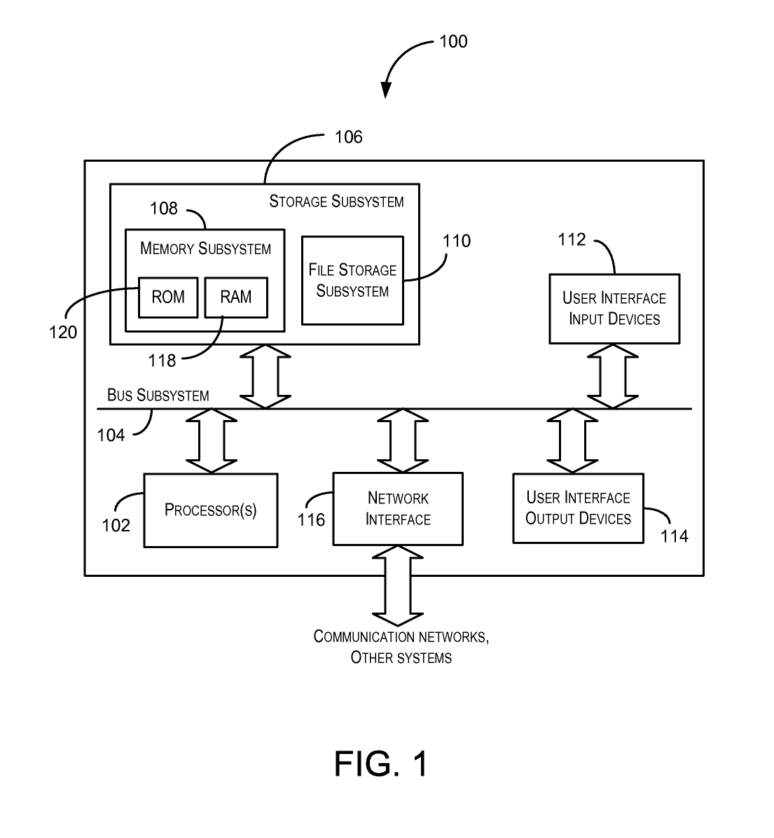

FIG. 1 is a simplified illustration of mobile device 100 that may incorporate an embodiment of the present invention.

Mobile device 100 may be embodied as a handset that is physically and technologically paired to a headset.

In various embodiments, a mobile device includes a handset that is physically and technologically paired to a headset. In one embodiment, a charger is provided that charges the mobile device, including both and the handset and the headset simultaneously with one power cord. In another embodiment, built-in storage and charging dock is provided for paired wireless and wired headsets.

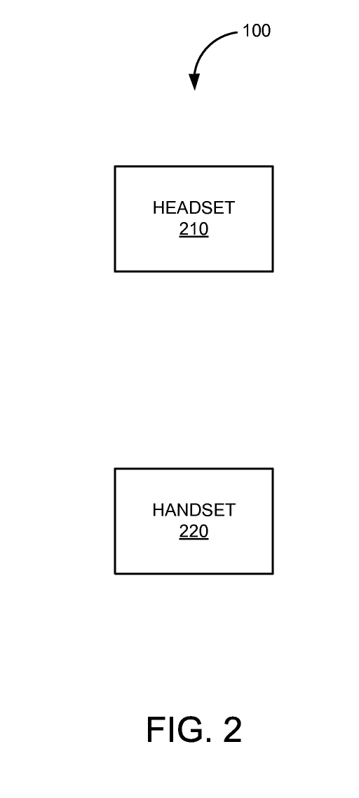

FIG. 2 is a simplified illustration of mobile device 100 in one embodiment.

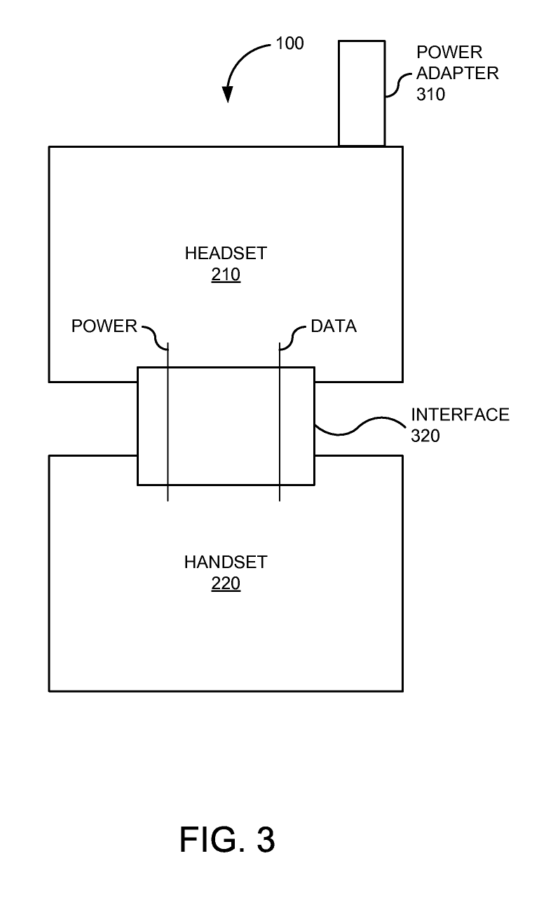

FIG. 3 is a simplified illustration of mobile device 100 in one embodiment.

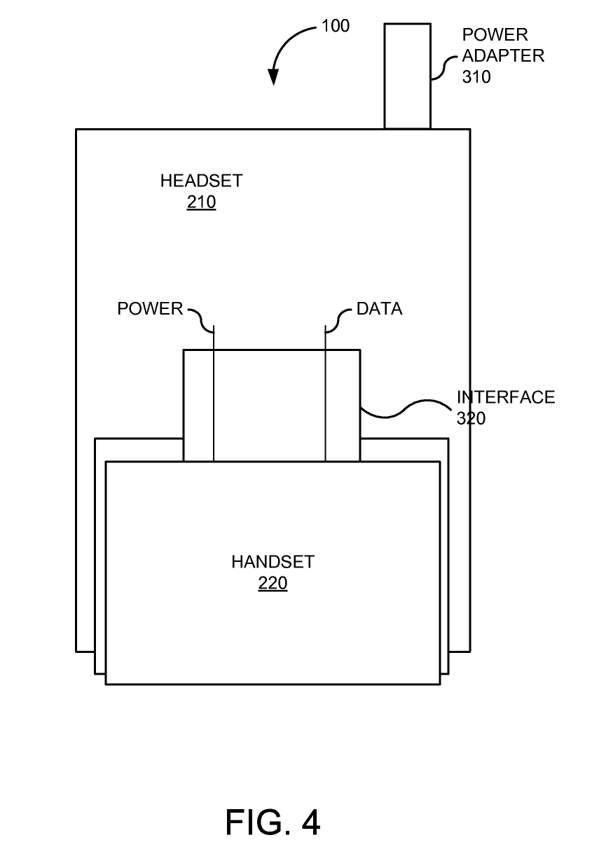

FIG. 4 is a simplified illustration of mobile device 100 in one embodiment.

Accordingly, the need for extra charging cables, and docking cradles is reduced, and the loss of the headset is less likely.

In various embodiments, a mobile device incorporates the integration of Interactive Voice Response software, grammar files, noise reduction or elimination, and the like, all within the headset, handset, or combination thereof associated with the mobile device. In one embodiment, the mobile device provides for a benchmark standard informing users that the paired headset/handset combination are optimum for use with Voice enabled software, much like the THX process used in the film industry.

Accordingly, various embodiments address the high failure rate of interactive voice response (IVR) systems, a significant percent of failure can be attributed to hostile ambient sound environments, as well as providing an all-in-one solution. In some embodiments, both a headset and a handset are fine tuned technologically and physically for optimum use of IVR systems, thus, significantly reducing the failure rate.

In another embodiment, IVR software (e.g., to analyze keywords or phases) is provided inside the headset, handset, or combination thereof reducing sound wave deterioration.

In another embodiment, voice commands are provided including voice dialing, SMS/MMS messaging, and access to any particular phone features such as calendars, memos, cameras, and the like.

In another embodiment, conference call mode is provided wherein two people can share the handset and headset on a conference call while in the same room without dialing a second line.

In another embodiment, multi-line support is provided so that one user can be on a call using the handset or headset while the other (or same) user can use the corresponding device to dial out and make a non-conference call.

In another embodiment, conference call mode is provided wherein multiple persons can opt to link into other calls within their area based on global positioning satellite, Bluetooth, wireless and the like. For example, as other callers enter the area they also may access the conference call.

In another embodiment, an alert is provided to notify the user that their designated contact is in the area. The parameters can be set from a few feet to miles using global positioning satellite, Bluetooth, wireless, and the like. As other designated callers enter the predetermined area all parties are alerted and can access the conference call.

In another embodiment, capabilities are provided, such as a universal remote and hooking into home automation systems to operate systems such as a garage doors, lights, and the like.

In another embodiment, secure access is provided to certain features of the unit only via voice print recognition combined with vocal security codes that utilize the one time pin (OTP) concept.

In various embodiments, methods and apparatus allow a call to be hear on both the head set and the handset simultaneously.

In another embodiment, methods and apparatus allow for two calls different calls to be to taken simultaneously one the headset and the other on the handset.

In another embodiment, a mobile device includes a cradle built into the top of a handset that a small, pen-like headset with an earpiece can be slid into and snaps securely into place. The headset can be released with a small catch and fitted into the ear of the user.

In another embodiment, an earpiece of a mobile device can be separated from a headset and snapped into a custom earpiece such as a disposable foam earplug, an ear gel, or a custom molding similar to a hearing aid.

In another embodiment, a headset of a mobile device utilizes a hook over the ear design similar to glasses. The headset has catches built into the unit that hangs in front of the ear that snap onto the headset like a pod, trapping the ear hook between the headset and handset.

In various embodiments, methods and apparatus provide access to a device. For example, a user associated with a first device establishes settings or preferences to be stored on the first device or stored through a service associated with the first device. The settings or preferences include information specifying other users and/or devices that are allowed to access the first device. The settings or preferences may indicate features of the first device, such as voicemail, GPS information, storage functions, multimedia functions, and the like. The settings or preferences may further include passwords, PINs, voice prints, and the like, that act as further security mechanism. The settings or preferences may include a username, a telephone number, an IP address, and the like. The settings or preferences may further include messages that are specific to a particular user.

In some embodiments, methods and apparatus provide access to content or features of a device based on the settings or preferences. For example, a user associated with a second device initiates a call or connection to the first device. The user of the second device then enters or otherwise obtains the voicemail of the user associated with the first device. Based on the settings or preferences established by the user of the first device, a message specific to the user of the second device is then presented. In various embodiments, based on the settings or preferences, multimedia information may be downloaded, voice recordings listened to, and other functions may be operated or accessed.

In one embodiment, the message informs the user that one or more features of the first device are accessible to the user of the second device. For example, the user of the second device may call the user of the first device. Based on the telephone number associated with the user of the second device, the user receives a message specific to the user of the second device indicating that one or more features of the first device are accessible to the user. The user of the second device may receive a message that a set of photos are available on the first device. The user of the second device then may provide a verbal utterance, a password, PIN, or other textual input to obtain access to the set of photos on the first device. The set of photos then may be viewed on or downloaded to the second device, or sent using the first device to another device. The user of the second device may further obtain access to the set of photos merely based on caller-ID information associated with the user.

FIG. 1 is a simplified illustration of a computer system that may incorporate an embodiment of the present invention. FIG. 1 is merely illustrative of an embodiment incorporating the present invention and does not limit the scope of the invention as recited in the claims. One of ordinary skill in the art would recognize other variations, modifications, and alternatives.

As shown in FIG. 1, apparatus 100 includes a processor 102 that communicates with a number of peripheral devices via a bus subsystem 104. These peripheral devices may include a storage subsystem 106, comprising a memory subsystem 108 and a file storage subsystem 110, user interface input devices 112, user interface output devices 114, and a network interface subsystem 116.

Bus subsystem 104 provides a mechanism for letting the various components and subsystems of apparatus 100 communicate with each other as intended. Although bus subsystem 104 is shown schematically as a single bus, alternative embodiments of the bus subsystem may utilize multiple busses.

Network interface subsystem 116 provides an interface to other computer systems, and networks, and devices. Network interface subsystem 116 serves as an interface for receiving data from and transmitting data to other systems from apparatus 100.

User interface input devices 112 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to apparatus 100.

User interface output devices 114 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from apparatus 100.

Storage subsystem 106 may be configured to store the basic programming and data constructs that provide the functionality of the present invention. Software (code modules or instructions) that provides the functionality of the present invention may be stored in storage subsystem 106. These software modules or instructions may be executed by processor(s) 102.

Storage subsystem 106 may also provide a repository for storing data used in accordance with the present invention. Storage subsystem 106 may comprise memory subsystem 108 and file/disk storage subsystem 110.

Memory subsystem 108 may include a number of memories including a main random access memory (RAM) 118 for storage of instructions and data during program execution and a read only memory (ROM) 120 in which fixed instructions are stored. File storage subsystem 110 provides persistent (non-volatile) storage for program and data files, and may include a hard disk drive, a floppy disk drive along with associated removable media, a Compact Disk Read Only Memory (CD-ROM) drive, a DVD, an optical drive, removable media cartridges, and other like storage media.

Computer system 100 can be of various types including a personal computer, a portable computer, a workstation, a network computer, a mainframe, a kiosk, a cell phone, a personal digital assistance (PDA), a smart phone, any wired/wireless communications device, or any other data processing system. Due to the ever-changing nature of computers and networks, the description of apparatus 100 depicted in FIG. 1 is intended only as a specific example for purposes of illustrating the preferred embodiment of the computer system. Many other configurations having more or fewer components than the system depicted in FIG. 1 are possible.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A mobile device comprising:
a handset; and
a headset configured to integrate with the handset for charging.
